(19) United States
(12) Patent Application Publication
(10) Pub. No.: US 2007/0101191 A1
(43) Pub. Date: May 3, 2007

(54) MEMORY DUMP METHOD, COMPUTER SYSTEM, AND MEMORY DUMP PROGRAM

(75) Inventor: HIDEO IWAMA, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tokyo (JP)

(21) Appl. No.: 11/554,994

(22) Filed: Oct. 31, 2006

(30) Foreign Application Priority Data
Oct. 31, 2005 (JP) 315982/2005

(51) Int. Cl. G06F 11/00

(52) U.S. Cl. 714/15

(57) ABSTRACT

A computer system of the present invention includes cells each of which includes a CPU and a memory, and partitions each of which is configured by combining any number of the cells. A service processor and a control element which controls reading and writing data for memory dumping are provided with the computer system. The cells includes a spare cell which does not belong to any of the partitions. If any of the partitions shuts down because of a system crash, the service processor disconnects the cell in the partition in which the system crash has occurred from the partition with memory information contained in the memory in the cell being held, and sets the spare cell into the partition. After the partition is booted, the control element writes the memory information contained in the memory in the disconnected cell onto the recording medium.

### BACKGROUND OF THE INVENTION

The present invention relates to a memory dump method, a computer system, and a memory dump program and, more particularly, to a memory dump method, a computer system, and a memory dump program capable of reducing down time of a system by using a small number of hardware (memory) components when a system crash occurs in the system.

Conventionally, a memory dump is obtained when a system crash occurs, and the system is rebooted after the memory dump is obtained.

Consequently, in the related memory dump, there is a problem that if a system crash occurs in a computer system containing very large memory, system down time increases because it takes a large amount of time for obtaining a memory dump.

As a measure against the problem, Japanese Patent Laid-Open No. 2004-102395 discloses a related method. In this method, the information processing system has duplicated memories, the same data is always held in both memories. In occurrence of the failure, data required for rebooting the information processing system is loaded in one of the memories to reboot the information processing system, and memory data is held in the other memory as memory dump data for the failure occurrence. In this way, down time of the system can be reduced and memory dump data can be obtained after rebooting the system. However, this related method has a problem that two memory, one of which is for loading data required for rebooting and the other of which is for holding memory dump data, are needed for each system.

### SUMMARY OF THE INVENTION

An object of the present invention is to provide a memory dump method, a computer system, and a memory dump program capable of reducing down time of a system by using a small number of hardware (memory) components when a system crash occurs in the system.

According to one aspect of the present invention, a memory dump method in a computer system in which a partition is configured by combining any number of cells with any number of input and output sections, wherein said cell consists of a CPU and a memory, the memory dump method comprising: disconnecting said cell constituting said partition in which a system crash has occurred, if any of said partitions shuts down because of said system crash, from said partition with memory information in said memory being held; setting a spare cell, which does not belong to any of said partitions, in said partition in which a system crash has occurred; booting said computer system; and writing said memory information contained in said memory in said disconnected cell onto a recording medium after booting said partition which has shut down because of said system crash.

### BRIEF DESCRIPTION OF THE DRAWINGS

Other features and advantages of the invention will be made more apparent by the following detailed description and the accompanying drawings, wherein:

FIG. 1 is a block diagram showing a main portion of a computer system according to one embodiment of the present invention;

FIG. 2 is a flowchart of an operation performed when a system crash occurs in partition P1; and

FIG. 3 is a flowchart of an operation performed to reboot partition 1.

In the drawings, the same reference numerals represent the same structural elements.

### DETAILED DESCRIPTION OF THE PREFERRED EMBODIMENTS

A first exemplary embodiment of the present invention will be described in detail below.

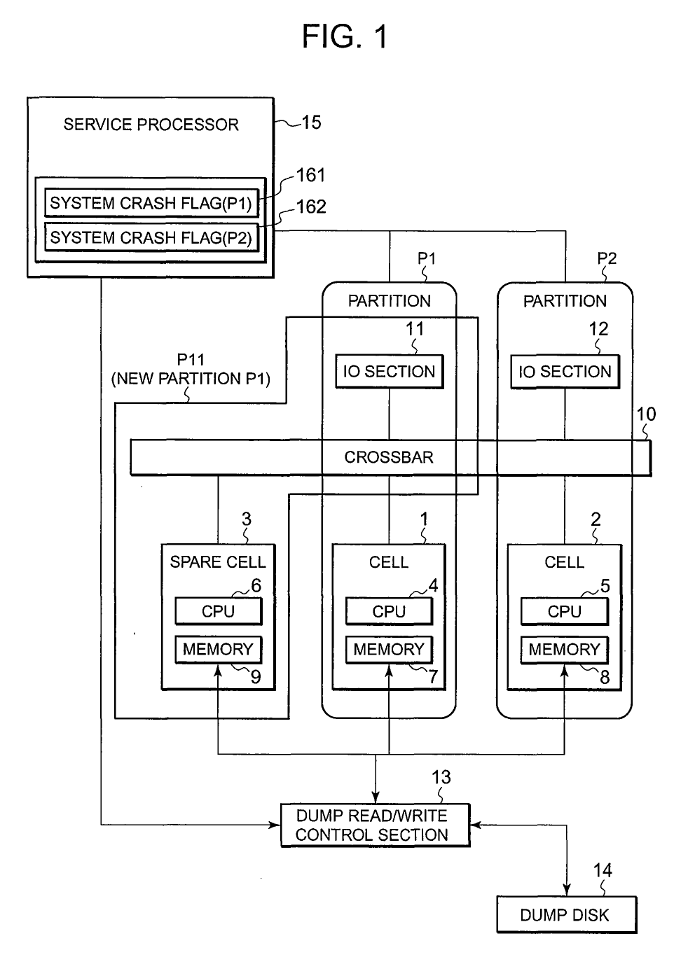

Referring to FIG. 1, a computer system according to the exemplary embodiment includes crossbar 10 capable of flexibly connecting any of cells 1, 2, and 3 to any of Input/Output (IO) sections 11 and 12. Cell 1 includes CPU 4 and memory 7. Cell 2 includes CPU 5 and memory 8. Cell 3 includes CPU 6 and memory 9. The computer system in the present embodiment has the following two partitions. Partition P1 includes cell 1 and IO section 11. Partition P2 includes cell 2 and IO section 12. Partitions P1 and P2 operate on different Operating Systems (Oss), respectively. Cell 3, which includes CPU 6 and memory 9, is a spare cell which does not belong to any of partitions P1 and P2, when the system starts the operation. It should be noted that one partition may include any number of IO sections and cells. Also, any number of spare cells may be provided with the computer system.

Dump read/write control section 13 reads memory information from memory 7 in cell 1, memory 8 in cell 2, or memory 9 in cell 3. Dump read/write control section 13 writes the memory information onto dump disk 14 by an instruction from service processor 15. Dump disk 14 may be any storage, for example, a hard disk on which information can be recorded.

Service processor 15 monitors whether a system crash has occurred in any of partitions 1 and 2. Service processor 15 has system crash flags 161 and 162 indicating whether a system crash has occurred in partitions 1 and 2, respectively. If a system crash occurs, system crash flag 161 or 162 is set to 1; if no system crash has occurred, system crash flags 161 and 162 are set to 0. Service processor 15 also controls how partitions P1 and P2 are to be configured with cells 1, 2 and 3 and IO sections 11 and 12 (partition configuration control) In particular, when service processor 15 recognizes that any of system crash flags 161 or 162 is changed from 0 to 1 due to a system crash, service processor 15 disconnects cell 1 in partition P1 or cell 2 in partition P2 in which the system crash has occurred and sets in spare cell 3 into the configuration. Service processor 15 also issues an instruction to initialize memory 9 in spare cell 3 included in partition P1 or P2 and issues an instruction to boot OS in partition P1 or P2.

In order to deal with a system crash which has occurred in both partitions P1 and P2 at a time; the number of spare cells 3 must be greater than or equal to the total of the number of cells in partition P1 and the number of cells in partition 2. In the present embodiment, partition 1 includes one cell and partition 2 also includes one cell, therefore two or more spare cells 3 are needed.

An operation of the present embodiment will be described below.

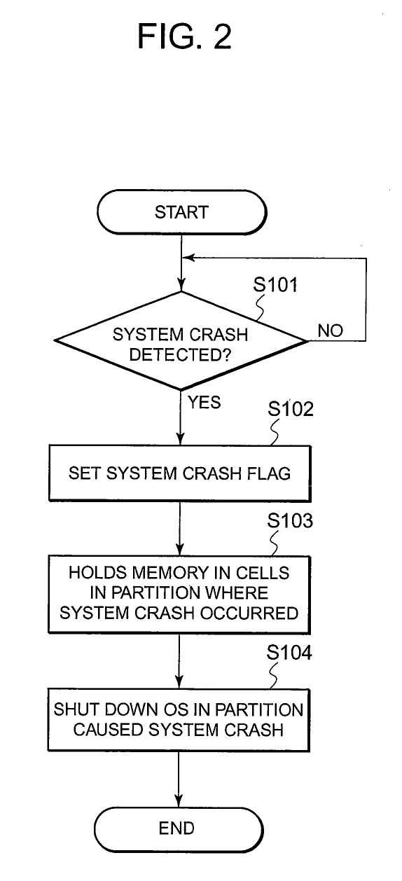

FIG. 2 is a flowchart of an operation performed if a system crash occurs in partition P1. The OS is preset such that a memory dump is not obtained when a system crash occurs. If a system crash occurs in partition P1 consisting of cell 1 and IO section 11, service processor 15 detects the system crash in partition P1 (step 101) and sets system crash flag 161 in service processor 15 (step 102). At the same time, service processor 15 holds the memory information contained in memory 7 in cell 1 belonging to partition P1 (step 103). Because it is preset on OS that a memory dump is not obtained when a system crash occurs, partition P1 consisting of cell 1 and IO section 11 shuts down the OS without obtaining a memory dump (step 104).

An operation performed for rebooting partition P1 will be described next.

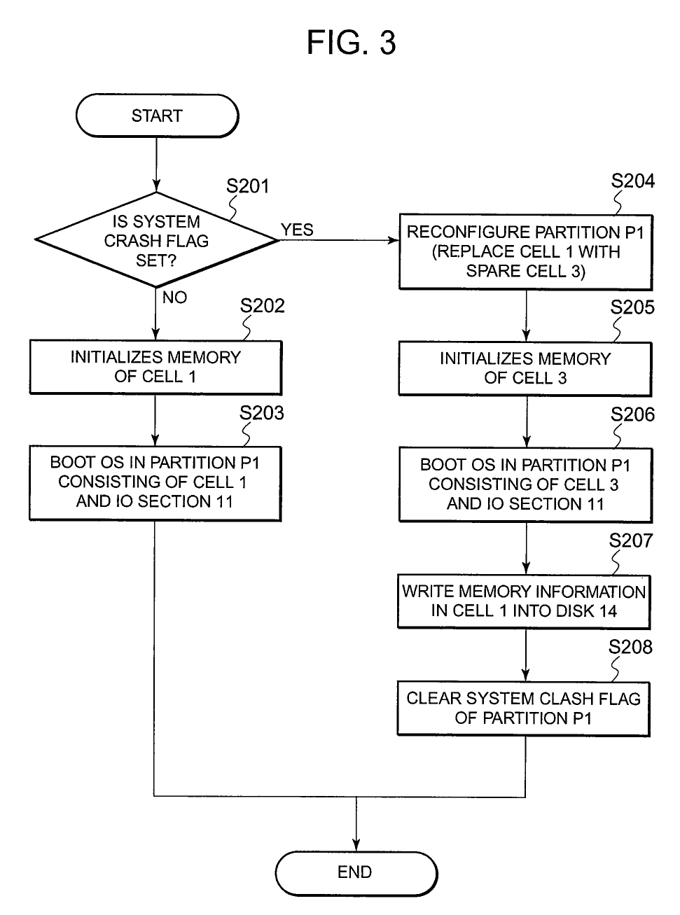

FIG. 3 is a flowchart of an operation performed for rebooting partition P1. Service processor 15 checks whether system crash flag 161 is set (step 201). If not, service processor 15 initializes memory 7 of cell 1 (step 202). Service processor 15 then boots the OS in partition P1 consisting of cell 1 and IO section 11 (step 203).

On the other hand, if system crash flag 161 in service processor 15 is set, service processor 15 instructs crossbar 10 to disconnect cell 1 which constitutes partition P1. In response to the instruction from service processor 15, crossbar 10 disconnects cell 1 constituting partition P1 and sets in cell 3 provided beforehand as a spare cell which does not belong to any of partitions P1 and P2 (step 204) into partition 1. New partition P1 is denoted by partition P11.

Then, when recognizing that setting in cell 3 is completed and new partition P1 (partition P11) is configured, service processor 15 initializes memory 9 of cell 3 which constitutes partition P1 (partition P11) (step 205). Service processor 15 then boots the OS in new partition P1 (partition P11) consisting of cell 3 and IO section 11 (step 206).

Then, in response to an instruction from service processor 15, dump read/write control section 13 reads the memory information from memory 7 of cell 1 constituting partition P1 at the time the system crash occurred and writes it on dump disk 14 (step 207). On notification by dump read/write control section 13 of completion of writing to dump disk 14, service processor 15 clears system crash flag 161 (step 208).

Similar operation in partition P2 is performed if a system crash occurs in partition P2. Cell 2 constituting partition P2 is disconnected from partition P2 and cell 3 provided beforehand as a spare cell is set in to produce a new partition P2 (partition P21). Then, service processor 15 boots the OS in the new partition P2 (partition P21) and obtains a memory dump.

A first effect of the present invention is that because memory information in a cell constituting a partition is held if a system crash occurs in the partition and the cell is replaced with a spare cell that does not belong to any partitions to reboot the OS, the OS can be rebooted without obtaining a memory dump after the system crash occurs, thereby reducing the down time.

A second effect of the present invention is that failure diagnosis can be surely executed because memory information in a partition where a system crash has occurred is saved and, after rebooting the OS, the memory information is obtained and stored on a dump disk.

A third effect of the present invention is that a spare cell to be replaced with a cell in the event of a system crash can be used for any of partitions and a spare cell does not need to be provided for each partition because a computer system is used in which any of cells and IO sections can be flexibly combined to configure a partition.

The configuration of partitions and the number of partitions and spare cells are not limited to those in the present invention.

Furthermore, processes described with respect to FIGS. 2 and 3 may be performed by a computer program.

What is claimed is:

1. A memory dump method in a computer system in which a partition is configured by combining any number of cells with any number of input and output sections, wherein said cell consists of a CPU and a memory, the memory dump method comprising:
disconnecting said cell constituting said partition in which a system crash has occurred, if any of said partitions shuts down because of said system crash, from said partition with memory information in said memory being held;
setting a spare cell, which does not belong to any of said partitions, in said partition in which a system crash has occurred;
booting said computer system; and
writing said memory information contained in said memory in said disconnected cell onto a recording medium after booting said partition which has shut down because of said system crash.

2. The memory dump method in a computer system according to claim 1, further comprising the step of initializing said spare cell after said spare cell is included in said partition.

3. The memory dump method in a computer system according to claim 2, further comprising the step of, if a system crash occurs, setting a system crash flag associated with said partition in which said system crash has occurred.

4. The memory dump method in a compute system according to claim 3, further comprising the step of determining, on the basis of said system crash flag, whether a boot of said partition is due to a system crash.

5. A computer system comprising:
cells each of which includes a CPU and a memory and is connected to an input and output section through a crossbar;
partitions each of which is configured by combining any number of said cells with any number of said input and output sections;
a service processor;
a control element which controls reading and writing data for memory dumping; and
a recording medium for memory dumping;
wherein said cells includes a spare cell which does not belong to any of said partitions,
wherein, if any of said partitions shuts down because of a system crash, said service processor disconnects said cell in said partition in which said system crash has occurred from said partition with memory information contained in said memory in said cell being held, and sets said spare cell into said partition, and
wherein, after said partition is booted, said control element writes said memory information contained in said memory in said disconnected cell onto said recording medium.

6. The computer system according to claim 5, wherein said spare cell is initialized after said spare cell is included in said partition.

7. The computer system according to claim 6, further comprising a system crash flag being associated with each of said partitions and indicating whether a system crash has occurred in said partition;
wherein if said system crash occurs, said service processor sets said system crash flag of said partition in which said system crash has occurred.

8. The computer system according to claim 7, wherein said service processor determines on the basis of said system crash flag whether a boot of said partition is due to a system crash.

9. A memory dump program in a computer system in which a partition is configured by combining any number of cells with any number of IO sections, wherein said cell consists of a CPU and a memory, the memory dump program causing a computer to perform the steps of:
disconnecting said cell constituting said partition in which a system crash has occurred, if any of said partitions shuts down because of said system crash, from said partition with memory information in said memory being held, and setting in a spare cell which does not belong to any of said partitions; and
writing said memory information contained in said memory in said disconnected cell onto a recording medium after booting said partition which has shut down because of said system crash.

10. The memory dump program in a computer system according to claim 9, further causing said computer to perform the step of initializing said spare cell after said spare cell is included in the partition.

11. The memory dump program in a computer system according to claim 10, further causing said computer to perform the step of, if a system crash occurs, setting a system crash flag associated with said partition in which said system crash has occurred.

12. The memory dump program in a computer system according to claim 11, further causing said computer to perform the step of determining, on the basis of said system crash flag, whether a boot of said partition is due to a system crash.
